(19) United States
(12) Patent Application Publication
(10) Pub. No.: US 2022/0232912 A1
(43) Pub. Date: Jul. 28, 2022

(54) ELECTROSTATICALLY DISSIPATIVE PROTECTIVE GLOVE AND METHOD OF PRODUCTION

(71) Applicant: Uvex Safety Gloves GmbH & Co. KG, Lüneburg (DE)

(72) Inventors: Karina Kloth, Lüneburg (DE); Matthias Bartusch, Lüneburg (DE)

(73) Assignee: Uvex Safety Gloves GmbH & Co. KG, Lüneburg (DE)

(21) Appl. No.: 17/615,149

(22) PCT Filed: Apr. 23, 2020
(86) PCT No.: PCT/EP2020/061294

§ 371 Date: Nov. 30, 2021

(30) Foreign Application Priority Data
May 31, 2019 (DE) 10 2019 114 691.7

(51) Int. Cl. A41D 19/00; A41D 31/26

(52) U.S. Cl. CPC A41D 19/0006; A41D 31/265; A41D 19/0065

(57) ABSTRACT

A method for producing a protective glove comprises preheating a dipping mold and fitting a knitted glove onto the dipping mold. The dipping mold with the knitted glove is immersed in a saline solution. The dipping mold with the knitted glove is then removed from the saline solution and dried. The dipping mold with the knitted glove is then immersed into a foamed latex compound with carbon fibers having a diameter between 2 μm to 25 μm. The dipping mold with the knitted glove is then removed from the latex compound and dried. The dipping mold with the knitted glove is then immersed in a water bath and then dried at a temperature between 100° C. to 130° C. before removing the finished glove from the dipping mold.

### CROSS REFERENCE TO RELATED INVENTION

This application is a national stage application pursuant to 35 U.S.C. § 371 of International Application No. PCT/EP2020/061294, filed on Apr. 23, 2020, which claims priority to, and benefit of, German Patent Application No. 10 2019 114 691.7, filed May 31, 2019, the entire contents of which are hereby incorporated by reference.

### TECHNICAL FIELD

The present disclosure relates to an electrostatically dissipative protective glove and to a method for producing an electrostatically dissipative protective glove.

### BACKGROUND

Electrostatically dissipative gloves play a special role within the field of protective gloves. For example, in explosive working areas, it must be ensured that electrostatic charges are dissipated.

It is known to incorporate additives into a polymer coating of protective gloves in order to positively influence various properties, such as abrasion resistance, grip, or flexibility. It is also known to incorporate electrically conductive additives into the coating in order to reduce the surface resistance and/or the volume resistance of the coating. For example, conductive carbon black dispersions are added to a polymer compound for the coating. On account of the spherical structure of the carbon black particles contained therein, they must be used in large amounts in order to achieve the desired electrical conductivity.

Alternatively, dispersions with elongated particles, such a carbon nanotubes, can be used, which are effective in smaller amounts due to their anisotropic properties. The disadvantage of using carbon nanotubes is that they must be added to the polymer compound in highly diluted dispersions in order to prevent the carbon nanotubes from agglomerating. Dispersions having less than 5% carbon nanotubes are common. As such, a larger amount of the dispersion must be used, which is only possible if the proportion of polymer in the polymer compound is reduced. However, reducing the proportion of polymer causes undesired changes to the properties, for example the pH value or the viscosity of the polymer compound.

A particular challenge is posed by protective gloves having a foamed polymer coating, as they have a high intrinsic volume resistance on account of insulating gas pockets. In addition, the majority of conventional conductive additives have the disadvantage that the stability of the foam decreases on account of a lower proportion of polymer. This means that the foam becomes coarser and/or denser within a relatively short space of time, i.e. it tends to collapse faster. As a result, consistent product quality cannot be ensured.

### BRIEF SUMMARY OF THE INVENTION

The object of the invention is to provide an electrostatically dissipative protective glove having a polymer foam layer, wherein the polymer foam has improved stability. Furthermore, the object of the invention is to provide a method for producing the protective glove according to the invention.

### BRIEF DESCRIPTION OF THE DRAWINGS

A more particular description of the invention briefly summarized above may be had by reference to the embodiments, some of which are illustrated in the accompanying drawings. It is to be noted, however, that the appended drawings illustrate only typical embodiments of this invention and are therefore not to be considered limiting of its scope, for the invention may admit to other equally effective embodiments. Thus, for further understanding of the nature and objects of the invention, references can be made to the following detailed description, read in connection with the drawings in which:

FIG. 1 schematically illustrates an embodiment of an electrostatically dissipative protective glove comprising a nitrile rubber foam layer and a textile substrate material on the inside.

### DETAILED DESCRIPTION

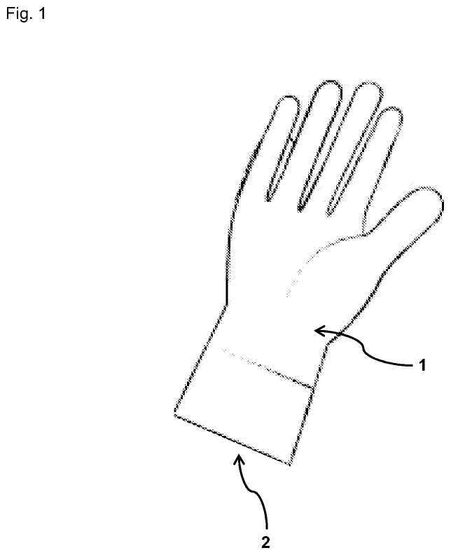

An embodiment of the disclosed protective glove as shown in FIG. 1 comprises at least two layers, wherein a first layer is a polymer foam layer 1. The polymer foam layer contains carbon fibers, which reduce the volume resistance. Carbon fibers are particularly suited for this application, since they can form conductive paths within the polymer matrix in smaller numbers than spherical particles on account of their elongated shape. Therefore, it is sufficient to add significantly fewer carbon fibers to the latex compound in order to produce the desired volume resistance. Furthermore, in contrast to carbon nanotubes, carbon fibers are added directly to the latex compound without having to be dissolved in a dispersion beforehand. Accordingly, the influence of the additive on the properties of the latex compound, for example the polymer content, viscosity, and pH value, and thus on the workability, is negligible. The mechanical properties of the finished glove also remain largely unaffected by the addition of the carbon fibers. Furthermore, it has surprisingly been found that the carbon fibers lead to greater foam stability compared with conventional conductive additives. In other words, the foam and thus also the product quality are stable for longer than in a compound without carbon fibers.

Preferably, the carbon fibers are comminuted carbon fibers with a length of between 10 μm and 1000 μm, particularly preferably between 50 μm and 250 μm. To achieve this, the fibers can be cut or ground, for example.

According to an embodiment, the diameter of the carbon fibers is significantly smaller than their length, preferably between 2 μm and 25 μm, particularly preferably between 3 μm and 9 μm. Fiber bundles consisting of several individual carbon fibers are also conceivable, the total diameter of which bundles may be larger, for example greater than 100 μm. It is also obvious to a person skilled in the art to use other electrically conductive synthetic or natural fibers that have been metalized or coated with conductive carbon black, for example, and which are available in a wide variety of shapes.

In an embodiment, the foam layer 1 may comprise synthetic or natural polymers. Preferably, the polymer foam layer comprises nitrile, chloroprene, isoprene, natural latex or polyurethane rubber, or a mixture of one or more of these constituents. Preferably, the polymer foam coating may contain other additives in addition to the carbon fibers according to the invention, for example crosslinking aids, thickeners, or color pigments. Particularly preferably, the polymer foam layer comprises substantially of nitrile rubber.

According to an embodiment, the polymer foam layer 1 is foamed, i.e. it contains gas pockets. It may in this case be a closed-pore foam or an open-pore foam or a mixture of both types. The pockets may contain air or another gas or gas mixture and be introduced in various ways. It is common practice for a person skilled in the art to use foam mixers or chemical foaming, for example.

In a preferred embodiment of the protective glove shown in FIG. 1, the second layer 2 of the glove comprises a textile substrate material. Knitted gloves of this kind increase the wearing comfort or provide protection against cuts, for example. The textile substrate is in contact with the skin of the user, whereas the polymer foam layer 1 forms the outer layer of the glove.

In another preferred embodiment of the protective glove, conductive yarns are incorporated into the textile substrate material. The conductive yarns produce the dissipative capacity of the textile substrate. Suitable materials for the conductive yarns may for example be metallic in nature (e.g. steel, copper, or silver), they may contain carbon fibers, and they may be yarns that have been metalized or conductively modified in another way.

In another embodiment, the protective glove comprises another, non-foamed polymer layer as a second layer 2 in addition to the foam layer 1 according to the invention. As such, a non-knitted glove can be provided by using a non-foamed polymer layer as the substrate for the foam layer according to the invention. This is expedient, for example, for chemical protective gloves. The non-foamed polymer layer in this embodiment can be electroconductively modified if necessary.

In an embodiment, the protective glove may comprise a multilayer system comprising a textile substrate, one or more non-foamed polymer layers, and the foam layer according to the invention. All additional layers may also be electroconductively modified. In a corresponding embodiment, the protective glove for example comprises a non-foamed polymer layer between the textile substrate and the polymer foam layer according to the invention. As a result, the high wearing comfort of the textile can be combined with the waterproofness of the non-foamed layer and the dissipative capacity of the polymer layer according to the invention.

Furthermore, combinations other of identical or different textile or polymer layers are conceivable. It is also obvious for the various layers to cover the glove to different extents. For example, knitted, mechanical protective gloves are only coated in the region of the fingers and palm. In contrast, chemical protective gloves are completely coated, i.e. including the cuff, but often have an additional grip layer that only covers the region of the fingers and palm.

In another preferred embodiment, the volume resistance of the protective glove according to the invention is less than 108 ohm. This meets the requirements for protective gloves from DIN EN 16350. According to the invention, this volume resistance can be achieved with a solids content of the carbon fibers in the latex compound of less than 4 wt. %.

An embodiment of a method according for producing a protective glove comprises the following steps relating to the nitrile rubber foam layer. Firstly, a latex compound is provided. It is preferably a latex compound containing nitrile rubber. Carbon fibers are added to the latex compound. The carbon fibers do not have to be in a suspension, but rather can be added to the latex compound directly, without any undesired agglomerations occurring. In a subsequent step, the compound is foamed. The foaming preferably takes place in a foam mixer by mechanically incorporating defined volumes of air into the latex compound. The added carbon fibers increase the stability of the foam. The foamed mass is then pumped into a dip tank.

In a preferred method for producing a non-knitted protective glove, a hand-shaped dipping mold is provided and immersed in the foamed latex compound containing the carbon fibers. The dipping mold may also have been treated with a coagulating saline solution prior to immersion. Subsequently, the glove is dried and pulled off.

In a preferred method for producing a knitted protective glove, the following steps are carried out. Firstly, a hand-shaped dipping mold is provided and preheated. The dipping mold preferably consists of aluminum or ceramic material. A knitted glove consisting of a textile substrate material is fitted onto the preheated dipping mold. Preferably, the knitted glove is interspersed with conductive yarns. Particularly preferably, the knitted glove is made in one piece, i.e. it is a so-called “seamless” glove. In a subsequent step, the dipping mold with the knitted glove is immersed in a coagulating saline solution. The coagulant prevents the rubber foam from fully penetrating the textile substrate before coagulation of the latex compound begins. In a subsequent step, the dipping mold is removed from the saline solution and dried. The dipping mold with the dried knitted glove is then immersed in the foamed latex compound containing the carbon fibers. Subsequently, the dipping mold is removed from the latex compound and pre-dried. Following this, the dipping mold with the—now coated—textile substrate is immersed in a water bath in order to remove excess coagulant. In a subsequent step, the dipping mold with the coated textile substrate is dried, preferably at temperatures of 100° C. to 130° C. In a final step, the finished protective glove is pulled off the dipping mold.

In a preferred method for producing a multilayer, knitted protective glove, the knitted glove on the hand mold is initially immersed in the coagulating saline solution, dried, and then immersed in a non-foamed coating compound. Subsequently, the coated glove is immersed in the foamed latex compound containing the carbon fibers. Afterwards, the dipping mold is removed from the latex compound, pre-dried, washed, dried, and finally the glove is pulled off the mold.

In an embodiment, the solids content of the carbon fibers in the latex compound is less than 4.0 wt. %, particularly preferably between 4.0 wt. % and 1.0 wt. %. It is advantageous that, with such a low solids content, the mechanical properties of the foam are not negatively affected, but rather the stability of the foam is in fact increased.

Referring to the exemplary embodiment of a knitted protective glove shown schematically in FIG. 1, the first layer 1 comprises a nitrile rubber foam layer 1 and the second layer 2 comprises a textile substrate material. When the glove is worn by the user, the second layer 2 is positioned on an inside or between the first layer 1 and the user's hand.

1-11. (canceled)

12. A protective glove comprising:
a first layer comprising,
a polymer foam, and
carbon fibers with a diameter of between 2 μm and 25 μm; and
a second layer, wherein the first layer at least partially covers the second layer.

13. The protective glove according to claim 12, wherein the first layer comprises at least one of: (1) nitrile; (2) chloroprene; (3) isoprene; (4) natural latex; and (5) polyurethane rubber.

14. The protective glove according to claim 12, wherein the first layer comprises nitrile rubber.

15. The protective glove according to claim 12, wherein the second layer comprises a textile substrate material.

16. The protective glove according to claim 15, wherein electrically conductive yarns are incorporated into the textile substrate material.

17. The protective glove according to claim 12, wherein the second layer comprises a non-foamed polymer layer.

18. The protective glove according to claim 12, wherein a volume resistance of the protective glove is less than 10⁸ ohm, measured according to DIN EN 16350.

19. A method for producing a first layer of a protective glove, the method comprising:
providing a latex compound;
adding carbon fibers to the latex compound, wherein the carbon fibers comprise a diameter of 2 μm to 25 μm;
incorporating a predefined volume of air into the latex compound containing the carbon fibers to foam the latex compound; and
immersing a dipping mold in the foamed latex compound.

20. A method for producing a protective glove, the method comprising:
preheating a dipping mold that comprises a shape of a hand;
fitting a knitted glove onto the dipping mold, wherein the knitted glove comprises a textile substrate material;
immersing the dipping mold with the knitted glove in a coagulating saline solution;
removing the dipping mold with the knitted glove from the coagulating saline solution;
drying the dipping mold with the knitted glove;
providing a latex compound;
adding carbon fibers to the latex compound, wherein the carbon fibers comprise a diameter of 2 μm to 25 μm;
incorporating a predefined volume of air into the latex compound containing carbon fibers to foam the latex compound;
immersing the dipping mold with the knitted glove in the latex compound to coat the knitted glove;
removing the dipping mold with the knitted glove from the latex compound;
pre-drying the dipping mold with the knitted glove;
immersing the dipping mold with the knitted glove in a water bath;
drying the dipping mold with the knitted glove at a temperature of between 100° C. to 130° C.; and
removing the knitted glove from the dipping mold.

21. The method according to claim 20, wherein solids content of the carbon fibers in the latex compound is less than 4 wt. %.

22. The method according to claim 20, wherein the latex compound comprises nitrile rubber.
